(19) United States
(12) Patent Application Publication
(10) Pub. No.: US 2008/0229396 A1
(43) Pub. Date: Sep. 18, 2008

(54) ISSUING A COMMAND AND MULTIPLE USER CREDENTIALS TO A REMOTE SYSTEM

(75) Inventors: Smita Bodepudi, Austin, TX (US); Medha Dinesh Date, Austin, TX (US); Murali Neralla, Austin, TX (US); Prasad Venkata Potluri, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 12/129,374

(22) Filed: May 29, 2008

Related U.S. Application Data
(63) Continuation of application No. 11/181,415, filed on Jul. 14, 2005.

(51) Int. Cl. H04L 9/32; G06F 21/00

(52) U.S. Cl. 726/4; 726/7

(57) ABSTRACT

A login shell and command access checking supporting multiple user credentials are provided. The login shell receives a request to execute a command from a remote computer including a multi-user credential. The login shell authenticates the command access rights of the multi-user credential. In response to command access rights being granted, the command is executed.

### BACKGROUND OF THE INVENTION

1. Field of the Invention

The present invention relates in general to a data processing system and, in particular, to a method, system, and computer program product for supporting multiple user credentials.

2. Description of the Related Art

Currently, whenever any user is logged into a multi-user or network environment, such as AIX or Windows, the login shell or environment allows for only one set of user credentials. That is, one user identification (ID), one primary group ID, and one or more secondary group IDs.

A problem arises when a user has more than one user account on a system, user1 and user2, for instance. The problem is that when the user is logged in under one account, user1, the user may only access a file if user1's credentials allow access, regardless of whether or not user2's credentials allow access to that file. Therefore, if a file has only been granted access for a user with user2's credentials, the user is not able to access that file while logged in as user1, even though user2 is also the user's account.

For example, on an AIX system, when a user, say aixuser1, is logged in, the logged in shell has only one user credential, one user ID, one primary group ID and one or more secondary group IDs. In the above example, the user has two user accounts, aixuser1 and aixuser2, and there are some files as follows:

| | |
|---|---|
| -rw------- 1 aixuser1 staff | 631365 Jun 14 13:56 peruser1.log |
| -rw------- 1 aixuser2 staff | 631365 Jun 14 13:56 peruser2.log |
| -rw------- 1 aixuser3 staff | 631365 Jun 14 13:56 peruser3.log |

The user cannot access both the files that he has permission to use from a one user credential environment when logged in as aixuser1.

The same is true under a windows environment. When a user is logged in to a Windows environment, the logged environment has only one user credential and one or more group credentials based on the group memberships. The same example mentioned above for the AIX environment also applies to the Windows environment.

Presently, there are three ways to get around these restrictions, but none of these solutions is very satisfactory or efficient. One solution is to create a new group consisting of the two user IDs and set the file's group ID as the newly created group. However, this solution is not practical, because the user needs to be a system administrator to create groups or to change group memberships.

Another solution is to use access control lists (ACLs) to provide access to the second user ID. Every time user1 creates a new file, user1 needs to grant ACL access to user2 and vice-versa. However, a problem arises when the user's IDs change. For example, user2 gets assigned to another user and the user gets assigned a new user ID of user3. Now all the files and directories owned by user1 with ACL access to user2 need to be identified and have the ACL access changed to user3 so that the files and directories owned by user1 are secured from user2. Additionally, files and directories that used to belong to user2 may also need to be identified and altered.

Another solution is to login as user1, work with the files owned by user1, then logout and login as user2 and work with the files owned by user2. This solution is not very practical as all the files cannot be accessed from one login shell or environment.

Other problems arise when issuing commands to a remote system. For example, in a Windows environment, when a remote share is mapped, the system sends the logged in user's username and password to the remote file server. If the logged in user has different user IDs on multiple systems to map the shares, the username and password need to be explicitly provided to each server.

In both the Windows and AIX environments, remote commands like rlogin, rsh, rcp, etc., use the user name and/or hostname in .rhosts file of the remote system. For example, if the /.rhosts file of aixsystem2 is aixsystem1 aixuser1 and the /.rhosts file of aixsystem3 is aixsystem1 aixuser2, then a user logged in as aixuser1 on aixsystem1 could execute remote commands on aixsystem2, but the user could not execute remote commands on aixsystem3, even though aixuser2 is one of the user's accounts. To execute commands on aixsystem3 from aixsystem1, user aixuser1 needs to log out and log in as aixuser2. However, this would then prevent the user from being able to execute any commands on aixsystem2.

### SUMMARY OF THE INVENTION

The present invention provides a method, system, and computer program product for supporting remote commands based on multiple user credentials. In the present invention, the method begins by receiving user input from a particular user including login information for a plurality of user accounts for that particular user. The plurality of user accounts is authenticated using the login information. A plurality of user credentials corresponding to the plurality of user accounts is retrieved. This plurality of user credentials forms a multi-user credential. A remote command is performed on a remote computer based on the multi-user credential. The command access rights to the remote computer are verified by verifying the command access rights of the multi-user credential. In response to command access rights being granted, the remote computer executes the command.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which exemplary aspects of the present invention may be implemented;

FIG. 2 is a block diagram of a data processing system that may be implemented as a server, in accordance with illustrative embodiments of the present invention;

FIG. 3 is a block diagram of a data processing system in which exemplary aspects of the present invention may be implemented;

FIG. 4 is a pictorial representation of a login screen in accordance with an exemplary embodiment of the present invention;

FIG. 5 is a block diagram of a system for executing a command on a remote computer using a multi-user credential in accordance with an exemplary embodiment of the present invention;

FIG. 6 is a flowchart illustrating the operation of executing a command on a remote computer using a multi-user credential in accordance with an exemplary embodiment of the present invention;

FIG. 7 is a block diagram of a system for executing a command on a remote computer that does not support multiple user credentials in accordance with an exemplary embodiment of the present invention; and

FIG. 8 is a flowchart illustrating the operation of executing a command on a remote computer in accordance with an exemplary embodiment of the present invention.

### DETAILED DESCRIPTION OF THE PREFERRED EMBODIMENT

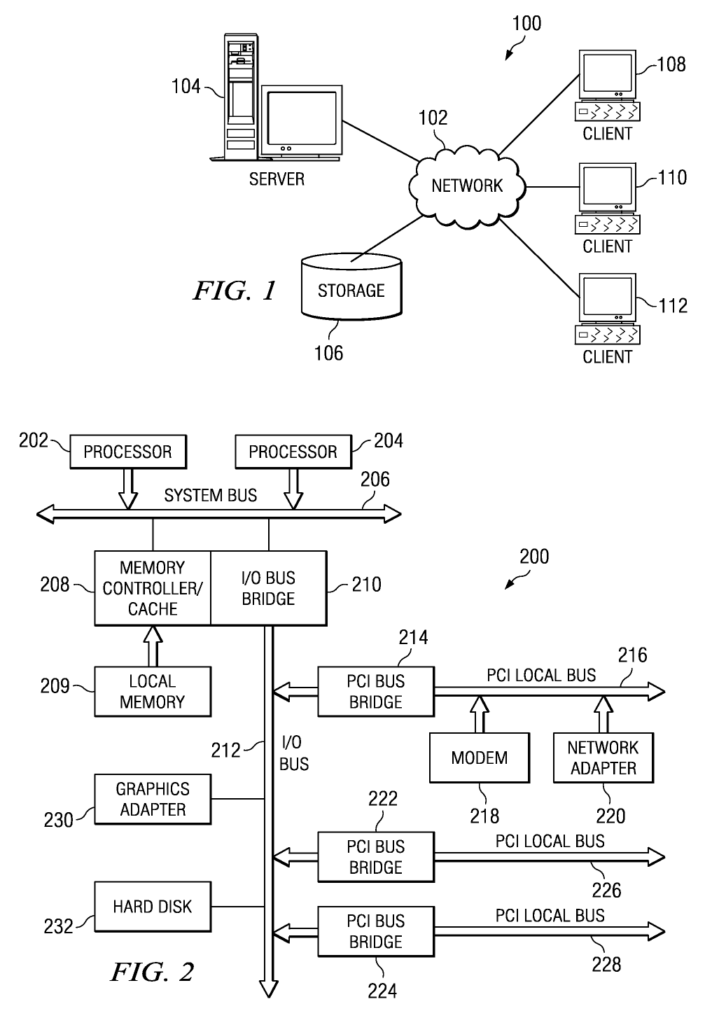

FIGS. 1-3 are provided as exemplary diagrams of data processing environments in which exemplary aspects of the present invention may be implemented. It should be appreciated that FIGS. 1-3 are only exemplary and are not intended to assert or imply any limitation with regard to the environments in which the present invention may be implemented. Many modifications to the depicted environments may be made without departing from the spirit and scope of the present invention.

With reference now to the figures, FIG. 1 depicts a pictorial representation of a network of data processing systems in which exemplary aspects of the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 connects to network 102 along with storage unit 106. In addition, clients 108, 110, and 112 connect to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with an illustrative embodiment of the present invention. Data processing system 200 may be a symmetric multiprocessor (SMP) system including a plurality of processors 202 and 204 that connect to system bus 206. Alternatively, a single processor system may be employed. Also connected to system bus 206 is memory controller/cache 208, which provides an interface to local memory 209. I/O bus bridge 210 connects to system bus 206 and provides an interface to I/O bus 212. Memory controller/cache 208 and I/O bus bridge 210 may be integrated as depicted.

Peripheral component interconnect (PCI) bus bridge 214 connects to I/O bus 212 to provide an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both, while Linux is a trademark of Linus Torvalds in the United States, other countries, or both).

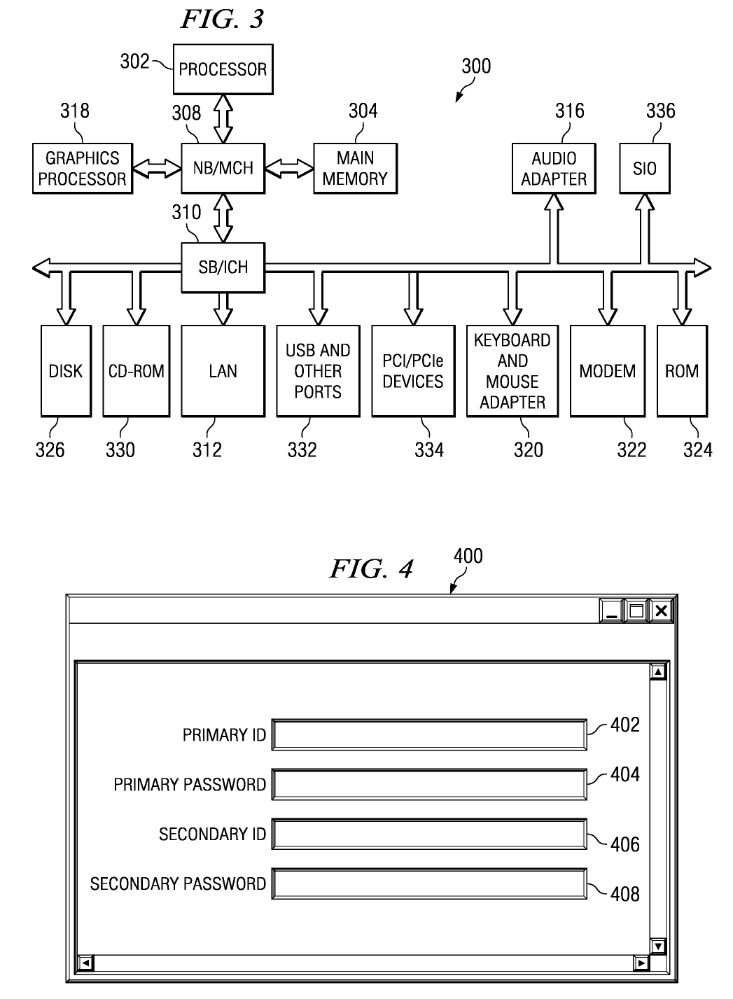

With reference now to FIG. 3, a block diagram of a data processing system is shown in which exemplary aspects of the present invention may be implemented. Data processing system 300 is an example of a computer, such as client 108 in FIG. 1, in which code or instructions implementing the processes of the present invention may be located. In the depicted example, data processing system 300 employs a hub architecture including a north bridge and memory controller hub (MCH) 308 and a south bridge and input/ output (I/O) controller hub (ICH) 310. Processor 302, main memory 304, and graphics processor 318 are connected to MCH 308. Graphics processor 318 may be connected to the MCH through an accelerated graphics port (AGP), for example.

In the depicted example, local area network (LAN) adapter 312, audio adapter 316, keyboard and mouse adapter 320, modem 322, read only memory (ROM) 324, hard disk drive (HDD) 326, CD-ROM driver 330, universal serial bus (USB) ports and other communications ports 332, and PCI/PCIe devices 334 connect to ICH 310. PCI/PCIe devices may include, for example, Ethernet adapters, add-in cards, PC cards for notebook computers, etc. PCI uses a card bus controller, while PCIe does not. ROM 324 may be, for example, a flash binary input/ output system (BIOS). Hard disk drive 326 and CD-ROM drive 330 may use, for example, an integrated drive electronics (IDE) or serial advanced technology attachment (SATA) interface. A super I/O (SIO) device 336 may be connected to ICH 310.

An operating system runs on processor 302 and coordinates and provides control of various components within data processing system 300 in FIG. 3. The operating system may be a commercially available operating system such as the Microsoft® Windows® XP operating system (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 300 (Java is a trademark of Sun Microsystems, Inc. in the United States, other countries, or both).

Instructions for the operating system, the object-oriented programming system, and applications or programs are located on storage devices, such as hard disk drive 326, and may be loaded into main memory 304 for execution by processor 302. The processes of the present invention are performed by processor 302 using computer implemented instructions, which may be located in a memory such as, for example, main memory 304, memory 324, or in one or more peripheral devices 326 and 330.

Those of ordinary skill in the art will appreciate that the hardware in FIGS. 1-3 may vary depending on the implementation. Other internal hardware or peripheral devices, such as flash memory, equivalent non-volatile memory, or optical disk drives and the like, may be used in addition to or in place of the hardware depicted in FIGS. 1-3. Also, the processes of the present invention may be applied to a multiprocessor data processing system. As some illustrative examples, data processing system 300 may be a personal digital assistant (PDA), which is configured with flash memory to provide non-volatile memory for storing operating system files and/or user-generated data.

A bus system may be comprised of one or more buses, such as system bus 206, I/O bus 212 and PCI buses 216, 226 and 228 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 218 or network adapter 220 of FIG. 2 or modem 322 or LAN 312 of FIG. 3. A memory may be, for example, local memory 209 or cache such as that found in memory controller/ cache 208 of FIG. 2 or main memory 304 of FIG. 3. A processing unit may include one or more processors or central processing units, such as processor 202 or processor 204 of FIG. 2 or processor 302 of FIG. 3. The depicted examples in FIGS. 1-3 and above-described examples are not meant to imply architectural limitations. For example, data processing system 300 also may be a tablet computer, laptop computer, or telephone device in addition to taking the form of a PDA.

FIG. 4 is a pictorial representation of a login screen in accordance with an exemplary embodiment of the present invention. The login screen is designated by reference number 400. Login screen 400 comprises input location 402 for inputting the user's primary ID, input location 404 for inputting the user's password for the user's primary ID, the primary password, input location 406 for inputting the user's secondary ID, and input location 408 for inputting the user's password for the user's secondary ID, the secondary password. While FIG. 4 depicts a login screen capable of accepting two different user IDs and passwords, those skilled in the art will realize that the screen could be modified to accept any number of user IDs and passwords. The depiction of a login screen capable of accepting two different user IDs and passwords is shown to illustrate exemplary aspects of the present invention but is not meant to imply any specific limitations on the invention.

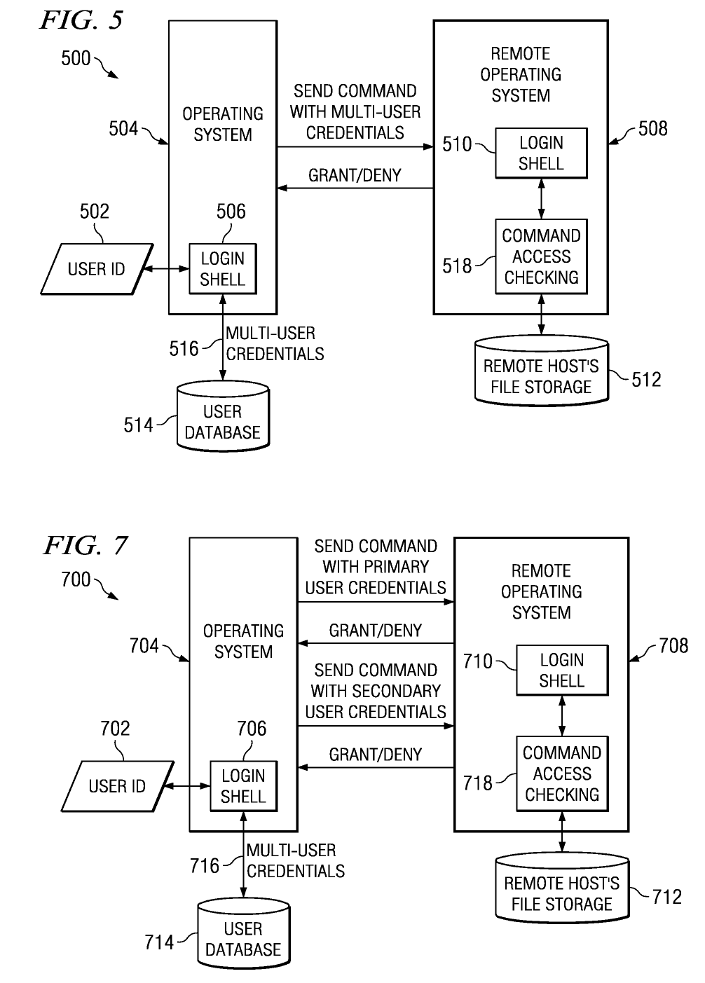

FIG. 5 is a block diagram of a system for executing a command on a remote computer using a multi-user credential in accordance with an exemplary embodiment of the present invention. The system is designated by reference number 500. Login information 502 comprises the users' primary and secondary IDs and passwords. Login information 502 is input into login shell 506 via an input screen, such as input screen 400 in FIG. 4. Login shell 506 is part of operating system (OS) 504. Login shell 506 communicates with user database 514 to obtain multi-user credentials 516.

User credentials comprise the user's ID and the user's primary group ID and any secondary group IDs. Multi-user credentials comprise a set of multiple user credentials for one individual user. In the present example, multi-user credentials 516 comprise the user's primary and secondary IDs and the user's primary and secondary group IDs. In the case of multi-user credentials, the set of secondary group IDs comprises the user's set of secondary group IDs for the user's primary ID, the primary group ID of the user's secondary ID, and the set of secondary group IDs for the user's secondary ID. In order to avoid security issues, the scope of multi-user credentials 516 is the life of login shell 506. While multi-user credentials 516 have been described in terms of comprising a primary user credential and a secondary user credential, multi-user credentials 516 could comprise any number of additional credentials belonging to the user.

A command for execution, along with multi-user credentials 516, is sent to login shell 510, which is part of remote operating system 508. Login shell 510 communicates with command access checking 518, which communicates with remote hosts file storage 512 to verify multi-user credentials 516 are associated with a user account having command access rights. Login shell 510 sends a response either granting or denying access back to OS 504 depending on the result of the outcome of the verification.

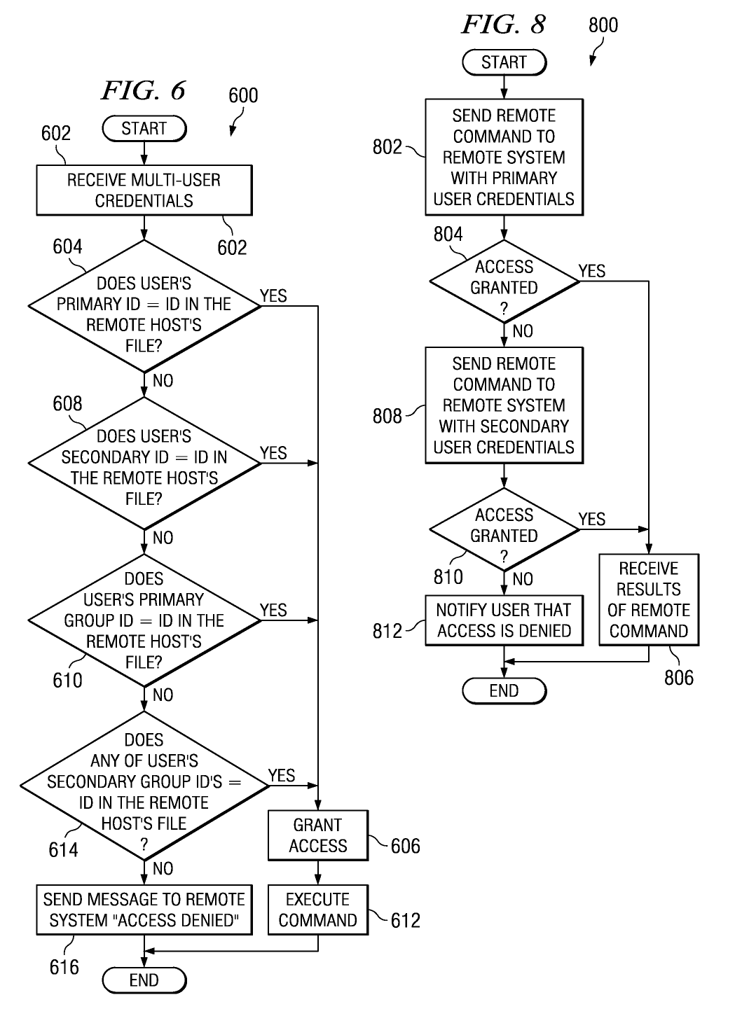

FIG. 6 is a flowchart illustrating the operation of executing a command on a remote computer using a multi-user credential in accordance with an exemplary embodiment of the present invention. The operation of executing a command on a remote data processing system using a multi-user credential is designated by reference number 600. Operation begins when the login shell, such as login shell 510 in FIG. 5, of the remote computer receives multi-user credentials, such as multi-user credentials 516 in FIG. 5, (step 602). The remote computer determines if the user's primary ID is one of the IDs contained in the remote hosts file (step 604). If the user's primary ID is one of the IDs contained in the remote hosts file (a yes output from step 604), the command access checker grants access (step 606), the command is executed (step 612), and operation ends.

If the user's primary ID is not one of the IDs contained in the remote hosts file (a no output from step 604), the remote computer determines if the user's secondary ID is one of the IDs contained in the remote hosts file (step 608). If the user's secondary ID is one of the IDs contained in the remote hosts file (a yes output from step 608), the command access checker grants access (step 606), the command is executed (step 612), and operation ends. If the user's secondary ID is not one of the IDs contained in the remote hosts file (a no output from step 608), the remote computer determines if the user's primary group ID is one of the IDs contained in the remote hosts file (step 610). If the user's primary group ID is one of the IDs contained in the remote hosts file (a yes output from step 610), the command access checker grants access (step 606), the command is executed (step 612), and operation ends.

If the user's primary group ID is not one of the IDs contained in the remote hosts file (a no output from step 610), the remote computer determines if any of the user's secondary group IDs is one of the IDs contained in the remote hosts file (step 614). The user's secondary group ID comprises all secondary group IDs of the user's primary ID and all group IDs of the user's secondary ID. If any of the user's secondary group IDs matches one of the IDs contained in the remote hosts file (a yes output from step 614), the command access checker grants access (step 606), the command is executed (step 612), and operation ends. If none of the user's secondary group IDs matches one of the IDs contained in the remote hosts file (a no output from step 614), the remote computer sends a message “access denied” to the computer that sent the command and multi-user credentials (step 616) and operation ends.

While the examples detailed above have been described in terms of a system where the remote hosts file uses only user IDs, one of ordinary skill in the art will recognize that the above detailed operation can apply to other implementations where the remote hosts file uses a hostname and user ID to authenticate command access. Examples of what comprises a hostname include, but are not limited to, a computer ID, a system ID, or a combination thereof. In such cases, the command access checker may operate as described, except that instead of checking to see if the user's ID matches one of the IDs in the remote hosts file, the command access checker checks to see if the combination of the user's ID and the system ID of the system sending the command and multi-user credential matches one of the IDs in the remote hosts file.

FIG. 7 is a block diagram of a system for executing a command on a remote computer that does not support multiple user credentials in accordance with an exemplary embodiment of the present invention. The system is designated by reference number 700. Login information 702 comprises the users' primary and secondary IDs and passwords. Login information 702 is input into login shell 706 via an input screen, such as input screen 400 in FIG. 4. Login shell 706 is part of operating system (OS) 704. Login shell 706 communicates with user database 714 to obtain multi-user credentials 716.

User credentials comprise the user's ID and the user's primary group ID and any secondary group IDs. Multi-user credentials comprise a set of multiple user credentials for one individual user. In the present example, multi-user credentials 716 comprise the user's primary and secondary IDs and the user's primary and secondary group IDs. In the case of multi-user credentials, the set of secondary group IDs comprises the user's set of secondary group IDs for the user's primary ID, the primary group ID of the user's secondary ID, and the set of secondary group IDs for the user's secondary ID. In order to avoid security issues, the scope of multi-user credentials 716 is the life of login shell 706. While multi-user credentials 716 have been described in terms of comprising a primary user credential and a secondary user credential, multi-user credentials 716 could comprise any number of additional credentials belonging to the user.

A command for execution on a remote computer is sent. In the case where the remote computer does not support the multi-user credentials 716, the command, along with the primary user credentials, is sent to login shell 710, which is part of remote operating system 708. Login shell 710 communicates with command access checking 718, which communicates with remote hosts file storage 712 to verify that the primary user credentials 716 are associated with an account having command access rights. Login shell 710 sends a response either granting or denying access back to OS 704 depending on the result of the outcome of the verification. If command access is granted, the command is executed.

If command access is not granted, a response denying access is returned to OS 704. The command is then re-sent, along with the user's secondary user credentials to login shell 710, which is part of remote operating system 708. Login shell 710 communicates with command access checking 718, which communicates with remote hosts file storage 712 to verify that the secondary user credentials 716 are associated with an account having command access rights. Login shell 710 sends a response either granting or denying access back to OS 704 depending on the result of the outcome of the verification. If command access is granted, the command is executed. If command access is not granted, a response denying access is returned to OS 704. OS 704 continues resending the command along with a set of the user's credentials until either access is granted or all of the user's credentials have been checked by command access checker 718 and access has been denied to all the user's credentials.

FIG. 8 is a flowchart illustrating operation of executing a command on a remote computer in accordance with exemplary aspects of the present invention. The operation of executing a command on a remote computer is designated by reference number 800 and begins when the local computer sends a remote command to a remote data processing system along with the primary user credentials (step 802). The remote computer determines whether access is granted (step 804). The determination may be based on a reply from the remote data processing system explicitly granting or denying access or other indicators may be used depending upon the implementation. If access is granted (a yes output from step 804), the local system receives the results of the remote command (step 806) and ends. The results of the remote command may take many forms including results of the executed command, a notification that the command was executed, or other indicators, depending upon the particular implementation.

If access is denied (a no output from step 804), the local data processing system sends the remote command to the remote data processing system along with the secondary user credentials (step 808). A determination is made as to whether or not access is granted (step 810). If access is granted (a yes output from step 810), the local system receives the results of the remote command (step 806), and operation ends. If access is denied (a no output from step 810), the user is notified that access to the remote system is denied (step 812) and operation ends.

It is important to note that while the above operation is described in terms of checking two sets of user credentials, primary and secondary, those of ordinary skill in the art will recognize that executing a remote command with multi-user credentials can be modified to continue sending the remote command to the remote data processing system coupled with other user credentials, continuing the process until all the credentials that a user possesses have been checked for access.

The invention can take the form of an entirely hardware embodiment, an entirely software embodiment or an embodiment containing both hardware and software elements. In an exemplary embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and digital video disk (DVD).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A computer implemented method for supporting remote commands based on multiple user credentials, the method including:
receiving user input from a given user including login information for a plurality of user accounts for the given user;
authenticating the plurality of user accounts based on the login information;
retrieving a plurality of credentials for the plurality of user accounts to form a multi-user credential; and
performing a remote command on a remote computer based on the multi-user credential.

2. The method of claim 1, wherein the multi-user credential includes a primary user identification, a primary group identification, a secondary user identification, and a plurality of secondary group identifications.

3. The method of claim 2, wherein performing the remote command includes sending a request to the remote computer, wherein the request includes the multi-user credential.

4. The method of claim 3, further including:
verifying, at the remote computer, command access rights of a computer that sent the request by verifying command access rights of the multi-user credential; and
responsive to the command access rights being granted, executing the command at the remote computer.

5. The method of claim 4, wherein the remote computer is a first remote computer and wherein execution takes place on a second remote computer.

6. The method of claim 4, wherein verifying the command access rights of the multi-user credential includes:
comparing the primary user identification to a plurality of user identifications in a remote hosts file; and
responsive to the primary user identification matching one user identification of the plurality of user identifications in the remote hosts file, granting command access to the computer that sent the request.

7. The method of claim 6, wherein verifying the command access rights of the multi-user credential further includes:
responsive to the primary user identification not matching a user identification of the plurality of user identifications in the remote hosts file, comparing the secondary user identification to a plurality of user identifications in a remote hosts file; and
responsive to the secondary user identification matching one user identification of the plurality of user identifications in the remote hosts file, granting command access to the computer that sent the request.

8. The method of claim 7, wherein verifying the command access rights of the multi-user credential further includes:
responsive to the secondary user identification not matching a user identification of the plurality of user identifications in the remote hosts file, comparing the primary group identification to a plurality of user identifications in a remote hosts file; and
responsive to the primary group identification matching one user identification of the plurality of user identifications in the remote hosts file, granting command access to the computer that sent the request.

9. The method of claim 8, wherein verifying the command access rights of the multi-user credential further includes:
responsive to the primary group identification not matching a user identification of the plurality of user identifications in the remote hosts file, comparing the plurality of secondary group identifications to a plurality of user identifications in a remote hosts file; and
responsive to one of the plurality of secondary group identifications matching one user identification of the plurality of user identifications in the remote hosts file, granting command access to the computer that sent the request.

10. The method of claim 1, wherein performing the remote command includes sending a request to the remote computer, wherein the request includes a primary user credential, wherein the primary user credential includes a primary user identification, a primary group identification, and secondary group identifications.

11. The method of claim 10, further including:
verifying, at the remote computer, command access rights of a computer that sent the request by verifying command access rights of the primary user credential credential; and
responsive to the command access rights being granted, executing the command at the remote computer.

12. The method of claim 11, further including:
responsive to the command access rights not being granted for the primary user credential, re-sending the request with a secondary user credential, wherein the secondary user credentials includes a primary user identification for the secondary credential, a primary group identification for the secondary credential, and secondary group identifications for the secondary credential.

13. A computer program product comprising:
a computer usable medium including computer usable program code for supporting multiple user credentials, said computer program product including:
computer usable program code for receiving user input from a given user including login information for a plurality of user accounts for the given user;
computer usable program code for authenticating the plurality of user accounts based on the login information;
computer usable program code for retrieving a plurality of credentials for the plurality of user accounts to form a multi-user credential; and
computer usable program code performing a remote command on a remote computer based on the multi-user credential.

14. The computer program product of claim 13, wherein the multi-user credential includes a primary user identification, a primary group identification, a secondary user identification, and a plurality of secondary group identifications.

15. The computer program product of claim 14, wherein performing the remote command includes sending a request to the remote computer, wherein the request includes the multi-user credential.

16. The computer program product of claim 15, further including:
computer usable program code for verifying, at the remote computer, command access rights of a computer that sent the request by verifying command access rights of the multi-user credential; and
computer usable program code, responsive to command access rights being granted, for executing the command at the remote computer.

17. The computer program product of claim 16, wherein the computer usable program code for verifying the command access rights of the computer that sent request by verifying the command access rights of the multi-user credential includes:
computer usable program code for comparing the primary user identification to a plurality of user identifications in a remote hosts file; and
computer usable program code, responsive to the primary user identification matching one user identification of the plurality of user identifications in the remote hosts file, for granting command access to the computer that sent the request.

18. The computer program product of claim 17, wherein the computer usable program code for verifying the command access rights of the computer that sent request by verifying the command access rights of the multi-user credential further includes:
computer usable program code, responsive to the primary user identification not matching a user identification of the plurality of user identifications in the remote hosts file, for comparing the secondary user identification to a plurality of user identifications in a remote hosts file; and
computer usable program code, responsive to the secondary user identification matching one user identification of the plurality of user identifications in the remote hosts file, for granting command access to the computer that sent the request.

19. The computer program product of claim 18, wherein the computer usable program code for verifying the command access rights of the computer that sent request by verifying the command access rights of the multi-user credential includes:
computer usable program code, responsive to the secondary user identification not matching a user identification of the plurality of user identifications in the remote hosts file, for comparing the primary group identification to a plurality of user identifications in a remote hosts file; and
computer usable program code, responsive to the primary group identification matching one user identification of the plurality of user identifications in the remote hosts file, for granting access to the computer that sent the request.

20. A data processing system for supporting remote commands based on multiple user credentials, the data processing system including:
a login shell that receives user input from a given user including login information for a plurality of user accounts for the given user and authenticates the plurality of user accounts based on the login information;
an operating system component that retrieves a plurality of credentials for the plurality of user accounts to form a multi-user credential; and
an operating system component that performs a remote command on a remote computer based on the multi-user credential.
